(19) United States
(12) Patent Application Publication
(10) Pub. No.: US 2013/0134144 A1
(43) Pub. Date: May 30, 2013

(54) ELECTRICAL SOLDERING IRON

(71) Applicant: GUAN-NAN REN, Shenzhen City (CN)

(72) Inventor: GUAN-NAN REN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/332,390

(22) Filed: Dec. 21, 2011

(30) Foreign Application Priority Data
Nov. 25, 2011 (CN) 201110380346.5

(51) Int. Cl. B23K 11/00

(52) U.S. Cl. 219/148

(57) ABSTRACT

An electrical soldering iron includes a handle, a heating pole installed in the handle, an operation member slidably received in the handle, a first iron head, and a second iron head. The operation apparatus includes an operation member slidably received in the handle, a first abutting member, and a second abutting member. First ends of the first and second abutting members are connected to the operation member. The first ends of the first and second iron heads are rotatably connected to second ends of the first and second abutting member, respectively. The intersections of the first and second iron heads are pivotably mounted to the heating pole. The operation member is operated to allow the second ends of the first and second iron heads opposite to the operation member to move toward or away from each other as in a scissor linkage arrangement.

### BACKGROUND

1. Technical Field

The present disclosure relates to an electrical soldering iron.

2. Description of Related Art

Certain type of electronic component, such as a resistor or a capacitor, includes two pins to be soldered on two pads of a printed circuit board (PCB) through an electrical soldering iron. However, if the soldering of the two pins of the electronic component is not carried out in one operation, it would be inefficient and often time-consuming.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an electrical soldering iron.

FIG. 2 is an assembled, isometric view of the soldering iron of FIG. 1.

FIG. 3 is a plan view of the objects in FIG. 2, but showing the soldering iron in a state of use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

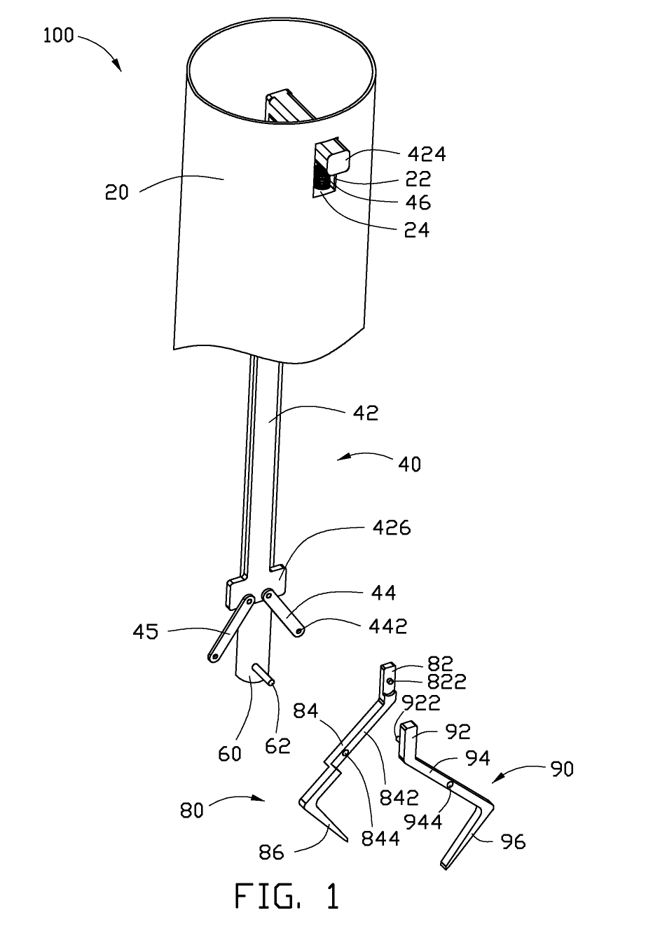

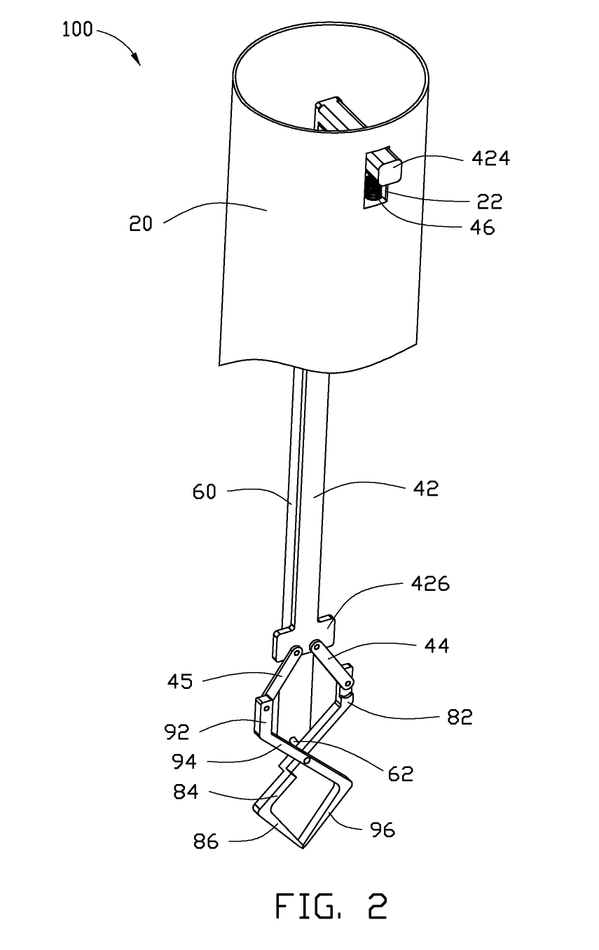

Referring to FIG. 1 and FIG. 2, an embodiment of an electrical soldering iron 100 includes a handle 20, an operation apparatus 40, a heating pole 60, a first iron head 80, and a second iron head 90.

The handle 20 is a cylindrical hollow shell, and defines a long slide slot 22 parallel to a lengthwise axis of the handle 20. A supporting piece 24 perpendicularly extends into the handle 20 from the peripheral wall, adjacent to a bottom end of the slide slot 22.

The operation apparatus 40 includes an operation member 42 slidably received in the handle 20 along the axis direction of the handle 20, a first abutting member 44, a second abutting member 45, and a resilient member 46. An operation pole 424 is diametrically positioned in the handle 20 and extends out through the slide slot 22 from a top end of the operation member 42. A connecting plate 426 extends down from a bottom end of the operation member 42. The resilient member 46 is sandwiched between the supporting piece 24 and the operation pole 424. The first abutting member 44 is substantially similar to the second abutting member 45, but in reverse. The first ends of the first and second abutting members 44 and 45 are mounted to a side surface of the connecting plate 426. The second ends of the first and second abutting members 44 and 45 opposite to the first ends each define a connecting hole 442. In the embodiment, the resilient member 46 is a coil or compression spring.

The heating pole 60 is installed in the handle 20 and is alongside the operation member 42 opposite to the first and second abutting members 44 and 45. The heating pole 60 is connected to a power supply (not shown). A heat-conducting shaft 62 extends straight out from a lower portion of the heating pole 60. The heat-conducting shaft 62 is in close physical contact with the connecting plate 426.

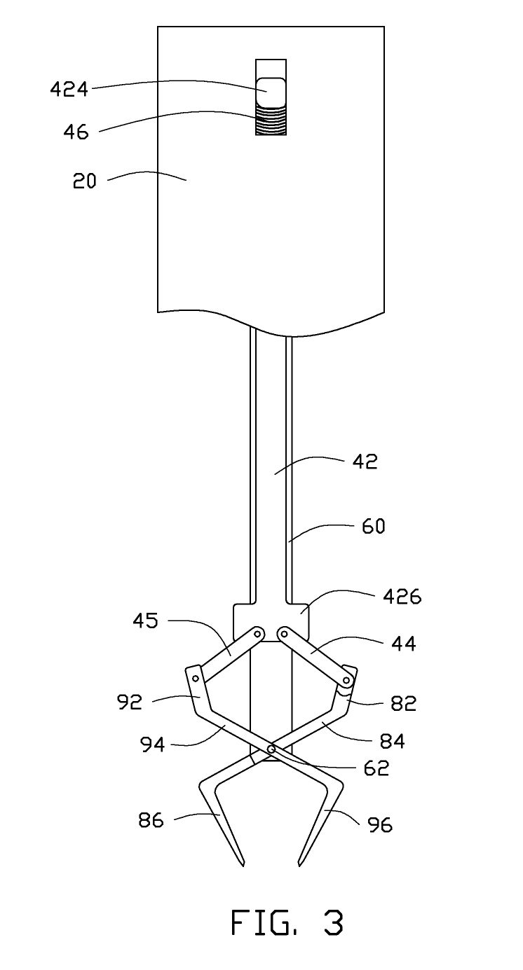

Referring to FIG. 3, the first iron head 80 is substantially similar to the second iron head 90. The first iron head 80 is substantially V-shaped, and includes a slanted pivoting bar 84 and a clamping portion 86 slantingly extending down from a bottom end of the pivoting bar 84. An angle between the pivoting bar 84 and the clamping portion 86 is acute. A connecting portion 82 extends from a top end of the pivoting bar 84. The pivoting bar 84 is substantially “Z”-shaped and defines a receiving space 842 adjacent to the connecting portion 82. A shaft 822 perpendicularly extends from the connecting portion 82. A middle of the pivoting bar 84 defines a shaft hole 844 in the receiving space 844. The shaft hole 844 is parallel to the extending direction of the shaft 822.

The second iron head 90 is substantially V-shaped, and is substantially a mirror image of the first iron head 80. The second iron head 90 includes a pivoting bar 94, a clamping portion 96 slantingly extending down from a bottom end of the pivoting bar 84, and a connecting portion 92 extending from a top end of the pivoting bar 84. A shaft 922 perpendicularly extends from the connecting portion 92. The pivoting bar 94 defines a shaft hole 944 parallel to the extending direction of the shaft 922.

In assembly, the shaft 822 is pivotably inserted into the connecting hole 442 of the first abutting member 44, with the receiving space 842 opposite to the heating pole 60. The heat-conducting shaft 62 is pivotably inserted into the shaft hole 844. The shaft 922 is pivotably inserted into the connecting hole 442 of the second abutting member 45. The pivoting bar 94 extends through the receiving space 842. The heat-conducting shaft 62 is pivotably inserted into the shaft hole 944. Distal ends of the clamping portions 86 and 96 abut against each other. The first and second iron heads 80 and 90 can be rotated about the heat-conducting shaft 62 to bring the distal ends of the clamping portions 86 and 96 into contact with each other, or to separate them from each other.

In use, the operation pole 424 is pressed toward the supporting piece 24, to deform the resilient member 46 and move down the operation member 42. The first and second abutting members 44 and 45 abut against the first and second iron heads 80 and 90. Being acted upon in a manner similar to a scissors linkage, the first and second abutting members 44 and 45 are rotated. The first and second iron heads 80 and 90 are rotated about the heat-conducting shaft 62. The clamping portions 86 and 96 move away from each other, until the clamping portions 86 and 96 respectively engage the two opposite soldering pins of an electronic component (not shown). The operation pole 424 is then released. The resilient member 46 self-restores to allow the operation pole 424 to move up away from the supporting piece 24. The first and second iron heads 80 and 90 are moved back towards each other, to allow the clamping portions 86 and 96 to clamp the pins of the electronic component. As the heating pole 60 generates heat, the heat is conducted to the first and second iron heads 80 and 90 through the heat-conducting shaft 62. The clamping portions 86 and 96 heat the soldering pins of the electronic component, to allow the electronic component to be mounted to a printed circuit board (not shown) in a single operation.

After the electronic component has been mounted, the operation pole 424 is pressed toward the supporting piece 24 again, deforming the resilient member 46. The operation member 42 moves down. The clamping portions 86 and 96 are moved away from each other and thus release the electronic component.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An electrical soldering iron comprising:
a hollow handle;
a heating pole installed in the handle;
an operation apparatus comprising an operation member slidably received in the handle, a first abutting member, and a second abutting member, first ends of the first and second abutting members are connected to the operation member;
a first iron head; and
a second iron head intersecting with the first iron head;
wherein first ends of the first and second iron heads are rotatably connected to second ends of the first and second abutting member, intersections of the first and second iron heads are pivotably mounted to the heating pole, the operation member is operated to allow two second ends of the first and second iron heads to move toward or away from each other.

2. The electrical soldering iron of claim 1, wherein the operation apparatus further comprises a resilient member sandwiched between the handle and the operation member, to bias the operation member to allow the second ends of the first and second iron head to contact with each other.

3. The electrical soldering iron of claim 2, wherein the handle defines a slide slot parallel to a lengthwise axis of the handle, an operation pole is positioned in the hand and extends out through the slide slot from a top end of the operation member, the resilient member is received in the slide slot and abuts against the operation pole and a bottom end wall bounding the slide slot.

4. The electrical soldering iron of claim 3, wherein a heat-conducting shaft extends straight out from the heating pole below the operation member, the intersections of the first and second iron heads are pivotably connected to the heat-conducting shaft.

5. The electrical soldering iron of claim 4, wherein the first iron head is substantially V-shaped, and comprises a first pivoting bar and a first clamping portion acutely angled from the first pivoting bar, the first pivoting bar defines a first shaft hole, the second iron head is substantially a mirror image of the first iron head, and comprises a second pivoting bar and a second clamping portion, the second pivoting bar defines a second shaft hole, the heat-conducting shaft is rotatably inserted into the first and second shaft holes.

6. The electrical soldering iron of claim 5, wherein the first iron head further comprises a first connecting portion extending up from a top end of the first pivoting bar opposite to the first clamping portion; the second iron head further comprises a second connecting portion, the first and second connecting portions are rotatably connected the operation member, distal ends of the first and second clamping portions is operable to move toward or away from each other.

7. The electrical soldering iron of claim 6, wherein the operation member further comprises a connecting plate extending from a bottom end of the operation member opposite to the operation pole, first ends of the first and second abutting members are connected to the connecting plate, the second end of the first abutting member is rotatably connected to the first connecting portion, the second end of the second abutting member is rotatably connected to the second connecting portion.
